(19) United States
(12) Patent Application Publication
(10) Pub. No.: US 2015/0248595 A1
(43) Pub. Date: Sep. 3, 2015

(54) APPARATUS AND METHOD FOR AUTOMATIC LICENSE PLATE RECOGNITION AND TRAFFIC SURVEILLANCE

(71) Applicants: Mohammad Ayub Khan, Santa Clata, CA (US); Syed Muhammad Ziauddin, Islamabad (PK); Imran Ul Haq, Islamabad (PK); Nasir Mehmood, Islamabad (PK); Mehdi Hussain, Islamabad (PK); Syed Ali Hassan, Islamabad (PK); Moeen Tayyab, Islamabad (PK)

(72) Inventors: Mohammad Ayub Khan, Santa Clata, CA (US); Syed Muhammad Ziauddin, Islamabad (PK); Imran Ul Haq, Islamabad (PK); Nasir Mehmood, Islamabad (PK); Mehdi Hussain, Islamabad (PK); Syed Ali Hassan, Islamabad (PK); Moeen Tayyab, Islamabad (PK)

(73) Assignee: STREAMING NETWORKS INC., Santa Clara, CA (US)

(21) Appl. No.: 14/633,570

(22) Filed: Feb. 27, 2015

Related U.S. Application Data
(60) Provisional application No. 61/946,150, filed on Feb. 28, 2014.

(51) Int. Cl. G06K 9/62; G06K 9/00; G06K 9/32

(52) U.S. Cl. CPC G06K 9/6217; G06K 9/325; G06K 9/00771

(57) ABSTRACT

A reconfigurable license plate recognition (LPR) processing apparatus and method for facilitating rapid development of LPR applications of various kinds and forms are disclosed. The LPR apparatus consists of processing hardware and software that can be configured manually or automatically into a plurality of operating modes that are designed to match the needs of various LPR applications. One or a plurality of appropriately configured LPR processing apparatuses along with LPR cameras and other required equipment can be assembled and operated in desired modes to build a variety of small-scale and large-scale LPR products. In addition, the LPR processing apparatus can be reconfigured when needed to match the changing requirements of an evolving LPR application, thereby eliminating the need to develop application-specific LPR hardware and software.

### PRIORITY

The present application claims priority from a U.S. Provisional Patent Application, App. No. 61/946,150, titled “Apparatus and Method for automatic license plate recognition and traffic surveillance” and filed on Feb. 28 2014, which is also hereby incorporated by reference.

### FIELD OF THE INVENTION

The present invention generally relates to automatic license plate recognition (LPR) products. More specifically, the present invention relates to a multipurpose reconfigurable LPR processing apparatus having multiple modes of operation, and its use as a building block for realizing a wide range of LPR applications and products.

### BACKGROUND

The growing demand for security has prompted the use of intelligent surveillance systems that require minimum human intervention, reduce fatigue related errors, and help operators stay focused. Automatic license plate recognition is an intelligent technology that has proved itself as an effective surveillance tool for law enforcement and public safety in the transportation sector. With the rise in its popularity a multitude of LPR usages have been identified, and many LPR products targeting small scale and large scale applications have emerged. Depending upon their type and size, the LPR applications have numerous diverse requirements including single or multiple LPR cameras, local or remote storage devices, edge-based or central network storage facility, fixed camera or car-mounted mobile camera based plate capturing capability, video recording feature, data duplication capability, optical character recognition (OCR) tailored for a region of interest, data-mining options to search plates and images in the database, stand-alone PC independent operation, and remote connectivity with PCs and other smart devices. Product manufacturers have to keep up with the pace of the growing market trends and continuously enhance their products to meet the ever changing needs of upcoming LPR applications.

Because of the ease of availability, LPR product developers often use general purpose computers to deploy LPR software. However, this approach has its pitfalls as general purpose computing hardware is not ideally suited for real-time LPR applications. Besides, the high power requirements and large form factor of general purpose computing hardware are unsuitable for many covert and overt LPR applications. In addition, upcoming systems and frequent changes in the existing systems warrant expensive software and hardware upgrades requiring huge investment in time and resources. Furthermore, general purpose computing equipment do not in general meet the stringent security and reliability criteria needed for 24×7 surveillance operations of LPR systems.

Hence, a system and method are needed that are secure and reliable, and amongst other things, reduce the development cost and time-to-market needed to deploy the large variety of LPR applications.

### SUMMARY

A reconfigurable LPR processing apparatus is disclosed. In one embodiment, the invention consists of a DSP based processing apparatus of small form factor that runs LPR software and provides a plurality of interfaces with the outside world in the form of Universal Serial Bus (USB) ports for storage devices, Ethernet ports for network devices, analog and IP camera ports, video and audio input/output (I/O) jacks, general purpose I/O ports, serial data communication ports, IR based remote controller interface, front panel buttons interface and power I/O pins. The LPR processing apparatus may be configured to operate in a plurality of operating modes having overlapping or dissimilar feature sets. A change in operating mode may result in an LPR processing apparatus having entirely different attributes, characteristics and interfaces.

The attributes, characteristics and interfaces that the LPR apparatus can attain in different operating modes are preselected, and are designed keeping in view the typical requirements of LPR products. In a preferred embodiment, the LPR processing apparatus may be configured to store captured plate data on a locally connected USB storage device which can be a USB flash drive, solid state drive, hard disk and the likes. Alternatively, in another embodiment, the LPR processing apparatus may be configured to store captured plate data on a remotely connected network storage drive, or on both a locally connected and a remotely connected storage devices. In another embodiment, the LPR processing apparatus may be configured to operate in a fixed camera LPR processing mode or a car-mounted mobile camera LPR processing mode. In yet another embodiment, the LPR processing apparatus operates in a stand-alone mode with personal computer (PC) independent operation. Another preferred embodiment consists of an LPR processing apparatus functioning in a Web connected LPR operating mode. Other embodiments of the present invention comprise a network storage server mode for receiving and storing license plate data captured by other LPR processing apparatuses on a network, a network storage server mode with local LPR processing capability, LPR mode with video recording capability, LPR mode with data-mining options to search license plates and images in a local database, and operating modes having OCR options to target a region of interest. In addition, the LPR processing apparatus may be configured to use multiple graphical user interfaces tailored for standalone and Web based operations, and can operate with multiple control interfaces including front panel control, infra-red remote control and Web browser based control.

A method for realizing a wide range of automatic license plate recognition systems is disclosed. In one embodiment, one or a plurality of appropriately configured LPR processing apparatuses combined with LPR cameras and other accessories are arranged to set up a targeted LPR system. Each individual LPR processing apparatus used in setting up an LPR application is configured to have a defined role with desired attributes, characteristics and interfaces, and acts as a building block for the complete system. By relying on well tested configurable LPR building blocks, the final LPR product can be developed rapidly, thereby reducing time-to-market, and easily meets the high reliability criteria of security and surveillance systems. Moreover, whenever the need arises the individual LPR building blocks can be reconfigured and more building blocks can be added or removed to match the changing requirements of evolving LPR applications.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE FIGURES

The accompanying Figures, which are incorporated herein and form part of the specification, illustrate the present invention and, together with the description, further serve to explain the principles of the invention and to enable a person skilled in the relevant art(s) to make and use the invention.

FIG. 1 is a simplified block diagram illustrating one embodiment of a reconfigurable LPR processing apparatus;

FIG. 2 is a simplified block diagram illustrating the hardware components of one embodiment of the present invention;

FIG. 3 is a simplified diagram illustrating single LPR operating modes of the present invention with PC-independent configuration;

FIG. 4 is a simplified diagram illustrating single LPR operating modes of the present invention with PC-independent configuration;

FIG. 5 is a simplified diagram illustrating single LPR operating modes of the present invention with PC-independent configuration;

FIG. 6 is a simplified diagram illustrating single LPR operating modes of the present invention with PC-independent configuration;

FIG. 7 is a simplified diagram illustrating single LPR operating modes of the present invention with PC-independent configuration;

FIG. 8 is a simplified diagram illustrating single LPR operating modes of the present invention with connected PC/smart devices;

FIG. 9 is a simplified diagram illustrating single LPR operating modes of the present invention with connected PC/smart devices;

FIG. 10 is a simplified diagram illustrating single LPR operating modes of the present invention with connected PC/smart devices;

FIG. 11 is a simplified diagram illustrating multiple LPR based operating modes of the present invention with connected PC/smart devices;

FIG. 12 is a simplified diagram illustrating multiple LPR based operating modes of the present invention with connected PC/smart devices;

FIG. 13 is a simplified diagram illustrating multiple LPR based operating modes of the present invention with connected PC/smart devices;

FIG. 14 is a simplified diagram illustrating multiple LPR based operating modes of the present invention with connected PC/smart devices and remote storage servers;

FIG. 15 is a simplified diagram illustrating multiple LPR based operating modes of the present invention with connected PC/smart devices and remote storage servers;

FIG. 16 is a simplified diagram illustrating multiple LPR based operating modes of the present invention with connected PC/smart devices and remote storage servers;

FIG. 17 is a simplified diagram illustrating multiple LPR based operating modes of the present invention with connected PC/smart devices and remote storage servers;

FIG. 18 is a simplified diagram illustrating car-mounted multiple LPR based operating mode in one embodiment of the present invention;

FIG. 19 is a simplified diagram illustrating large scale LPR operating modes of the present invention;

FIG. 20 is a simplified diagram illustrating large scale LPR operating modes of the present invention;

FIG. 21 is a simplified depiction of the LPR apparatus enclosed in a camera housing, according to one embodiment of the present invention;

FIG. 22 is a simplified depiction of the LPR apparatus as part of an access control system, according to one embodiment of the present invention;

FIG. 23 is a depiction of the graphical user interface of camera installation mode in one embodiment of the present invention;

FIG. 24a is a user interface depicting different monitoring modes of a vehicle and its license plates in one embodiment of the present invention; and

FIG. 24b is a user interface depicting different monitoring modes of a vehicle and its license plates in one embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

The disclosure set forth below in connection with the appended drawings is intended as a description of various embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagrams in order to avoid obscuring the concepts of the present invention.

One or more embodiments of the present invention will now be described. In one embodiment, the present invention provides a reconfigurable processing apparatus for performing automatic license plate recognition (LPR). The LPR processing apparatus consists of a processing hardware and software that can be configured manually or automatically into a plurality of operating modes and can act as a building block for a wide range of LPR products targeting applications such as security and surveillance, law enforcement, parked car scanning, entry-exit systems, automatic vehicle access control, toll collection, community data logging, school bus safety, drive through customer service, monitoring financial institutions and other business concerns, traveling time measurement, border security, electronic fencing and traffic monitoring. In one aspect the processing apparatus offers a cost effective and convenient way to design LPR products and reduces the development cost and the time needed to deploy LPR applications.

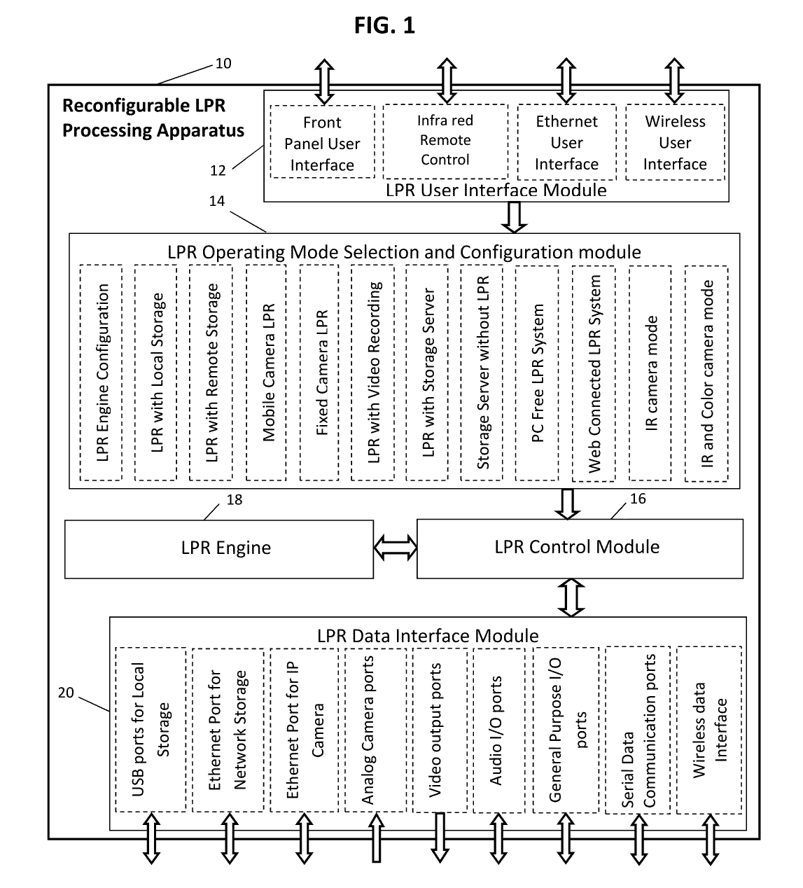

As noted above, the LPR processing apparatus of FIG. 1 acts as a flexible building block that can be configured automatically or through user commands to meet the needs of many different LPR applications. By relying on well tested configurable LPR building blocks, the final LPR product can be developed rapidly, and easily meets the high reliably criteria of security and surveillance systems. Moreover, whenever the need arises, the individual LPR building blocks can be reconfigured and more building blocks can be added or removed to match the changing requirements of evolving LPR applications. By virtue of the flexibility offered by the configurable LPR apparatus it can be used in a variety of situations, e.g., it can help law enforcement activities by uploading regional hot lists and signaling law enforcers when vehicles involved in various crimes are detected; in security and surveillance applications a network of connected LPR apparatuses can monitor public places and signal when suspicious, unwanted or blacklisted vehicles are detected; in entry-exit applications the LPR apparatuses can be used to run ticket-less parking systems thereby reducing congestion and delays, and minimizing losses; in parked car scanning applications the system can be used in mobile LPR mode to detect and charge parking violators; for school bus safety the LPR apparatus can be synchronized with the door opening of the school bus and to record license plate records and video footage of vehicles violating overtaking laws; in traffic monitoring applications a set of LPR apparatuses can be connected to a central server and measure traveling time of vehicles to help regulate traffic; and in border security applications the system can store data regarding border crossings and may be searched when needed.

In one embodiment as shown in FIG. 1, the LPR processing apparatus 10 contains means to support one or more user interfaces to match the specifications of different LPR applications. A user can interact with the processing apparatus by means of its interface module 12 that supports one or a plurality of user interfaces including a front panel button interface, infra red remote controller interface, Ethernet port based interface for users connected via networked devices, and interface for wirelessly connected users through devices supporting WiFi, Bluetooth, or any other wireless protocol. An embodiment of the LPR processing apparatus as shown in FIG. 1 contains further means to manually or automatically select one or more operating modes and configuration parameters to enable the apparatus to attain the desired attributes, characteristics and interfaces to match the requirements of different LPR applications. The operating mode selection and configuration module 14 of the processing apparatus 10 enables the selection of one or a plurality of operating modes including LPR operating mode with local storage of license plate data, LPR operating mode with remote storage of license plate data, operating mode tailored for mobile-camera LPR applications, operating mode tailored for fixed-camera LPR applications, LPR operating mode with vehicle video recording option, LPR operating mode with storage server option to store its own plate data and the data coming from other connected LPR apparatuses, storage server operating mode without local LPR processing, LPR operating mode to function as a stand-alone system, LPR operating mode to function as a network connected system, LPR operating mode with IR camera support, LPR operating mode with IR, color overview and color surround camera support, and LPR engine configuration modes for optimum performance in different states and regions. The selected operating modes and configuration parameters are used by the LPR control module 16 to configure and operate the LPR engine 18, and activate one or more data interfaces via the LPR data interface module 20 to perform data transmission and reception tasks. The LPR engine 18 captures and reads license plates using digital image processing and optical character recognition techniques, and based upon the selected operation modes generates plate records, plate images, vehicle images and associated video recordings for storage and/or transmission via the activated data interfaces. In an embodiment of the LPR processing apparatus as shown in FIG. 1, the LPR data interface module contains means to activate one or a plurality of data interfaces including Universal Serial Bus (USB) port(s) for storing plate records, images and associated video, Ethernet port(s) for external connectivity and network storage, Ethernet port(s) for Internet Protocol (IP) cameras, analog camera video input port(s), analog video output port(s) for connecting with analog display monitors, audio input/output (I/O) port(s) for sounding audio alarms and for audio communication, general purpose I/O port(s) for interfacing with external systems such as access control systems, serial data communication port(s) for connecting with GPS modules, Pan-Tilt-Zoom (PTZ) platforms and other devices, and wireless data interface(s) supporting WiFi, Bluetooth and other wireless protocols.

The configurable LPR processing apparatus of the present invention as described in the above paragraphs also includes means to integrate the LPR operation within large scale video management systems (VMS), providing VMS operators with LPR functionality as part of a wider security management plan.

An important aspect of the embodiment of FIG. 1 is its ability to record and store/transmit video data in association with plate records and other events. In one embodiment, the video footage of the color overview camera associated with the infrared LPR camera is recorded. Video data can be captured and processed by utilizing the computational resources of the LPR apparatus. Alternatively, video can be captured and processed by an external connected device such as a video encoder that sends the processed video to the LPR processing apparatus for tagging, storage and transmission. Video data may be tagged to facilitate searching and data mining on the basis of one or a plurality of events including license plate capture events, wanted (hot) license plates events, motion based events, external signals on a general purpose I/O port, user commands and other similar events. One usage of video recording within the LPR framework, as envisaged in the embodiment of FIG. 1, is to record overview camera footage to capture vehicle records even when the license plates are missing or unreadable. In another embodiment, in addition to recoding the overview camera footage, a pan-tilt-zoom controlled video camera is used to monitor and record surrounding areas, in-car videos and video footage of the drivers. The system can record video continuously or break it in event based video segments to save storage space. Moreover, video data may be compressed in a variety of formats including motion JPEG, H.264, H.265, Mpeg4, Mpeg2, H.263, VP8, VP9 or any other video format.

Another important aspect of the embodiment of FIG. 1 is its ability to search a target plate in its hot list or database even when the plate has been partially read. For this purpose the embodiment of FIG. 1 contains means to distinguish between similar characters through a probabilistic algorithm, and handle reading errors on the basis of syntax of license plates for a region of interest. It also contains means to perform exact, partial and fuzzy searches of one or more hot lists, as well as wild-card searches to seek out the target plates. A preferred embodiment of the present invention performs exact searches to find exact number matches, partial searches to find numbers with one or more incorrectly read characters, fuzzy searches to find numbers with incorrectly read characters as well as missing characters and extra insertions, and wild-card searches to search numbers with desired patterns. It may be noted that a hot list as supported by the embodiment of FIG. 1 may be interpreted as a black list for blocking the listed plate numbers, or a white list for blocking all plate numbers except the listed plate numbers.

It may further be noted that in the embodiment of FIG. 1 a USB interface is shown for data storage. This interface could easily be replaced by other data storage interfaces supporting one or more data storage devices including hard drives, flash drives, memory cards, USB controller based SATA drives, RAID devices and network attached storage devices. Similarly, an embodiment of the LPR processing apparatus can easily be visualized that stores data in its internal flash memory. In a preferred embodiment, a detachable storage device connected to the LPR processing apparatus houses the LPR database that can be searched by the apparatus for plate records. Alternatively, the storage device can be detached and reconnected to a PC or any smart device for independently searching the database and analysis. An embodiment of the LPR processing apparatus performs OCR function on the captured plate images either in real-time or in an off line fashion. Likewise, an embodiment of the LPR processing apparatus may carry out database searching on-the-fly while the LPR process is in progress or in an off line fashion. Furthermore, the embodiment of FIG. 1 shows Ethernet interface for IP cameras and analog video interface for analog cameras. It would be apparent to those skilled in the art that an embodiment of the present invention can easily be envisaged for different camera interfaces including HDMI, DVI, SDI, CSI and other similar interfaces. In a similar way, the embodiment of FIG. 1 shows a wireless data interface for wireless connectivity. It is apparent that wireless connectivity can also be achieved via other interfaces such as the USB interface through external dongles. All such modifications fall within the spirit and scope of the present invention.

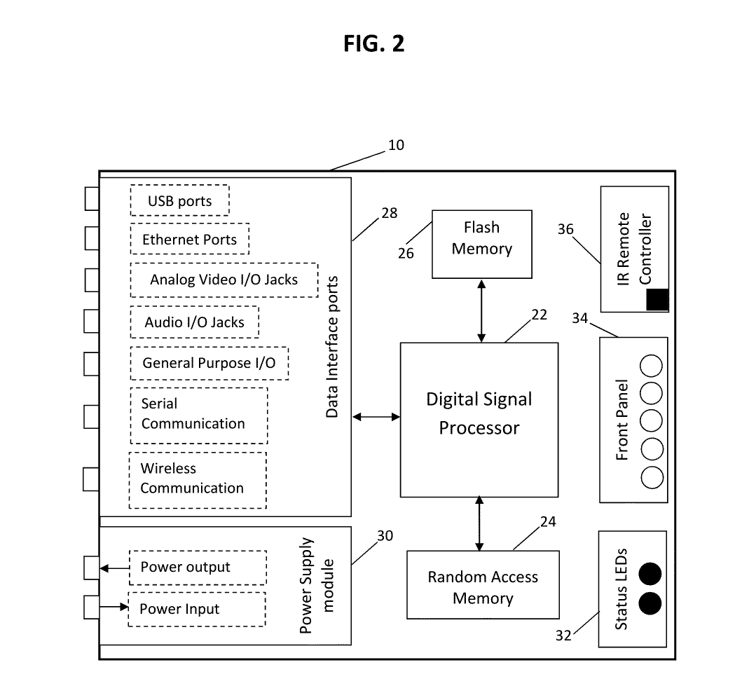

FIG. 2 is a simplified block diagram illustrating the hardware components of one embodiment of the present invention. The LPR processing apparatus 10 consists of a processing hardware that includes a Digital Signal Processor (DSP) 22, a Random Access Memory (RAM) 24, a Flash Memory 26, front panel buttons 34, IR remote controller circuitry 36, status LEDs 32, power supply module 30 and one or a plurality of data interface ports as described above in relation to FIG. 1. Data from the infrared and color cameras is fed to the DSP via the interface ports. In the embodiment of FIG. 2, the DSP executes the LPR algorithm to extract license plate and vehicle images from the camera signals, and processes these images using digital signal processing and OCR techniques to read the license plate numbers. Depending upon the selected operating modes the plate records are stored or transmitted. In a preferred embodiment of the present invention the DSP further supports one or a plurality of functions including hot list management, data mining, handling user interfaces, video recording, database management, rendering LPR results on display monitors, managing the graphical user interfaces, firmware upgrading, event tagging, system settings, managing GPIO signals, handling GPS data, sending Email/SMS messages and communicating with external applications. In FIG. 2 the front panel buttons 34 are used to provide a simple user interface in a stand-alone operating mode. Alternatively, an IR remote controller 36 may also be used by a user to interact with the LPR processing apparatus in a stand-alone operating mode. Other user interfaces are provided by Ethernet and wireless communication ports 28. The status LEDs 32 are used to signal the power ON/OFF state and the current status of the device including error conditions, connectivity and LPR engine states.

Different embodiments of the present invention may contain features like dynamic video source detection, whereby the selection of the appropriate camera input source is made automatically on the basis of the availability of the video signal; and dynamic video standard detection, whereby the selection of NTSC/PAL/SECAM video standards is made automatically. Different embodiments of the present invention may also provide support for FAT32, FAT16, HFS, HFS+, Ext2, Ext3, NTFS, or any other standard or proprietary file system for storing plate records, images and video files. Moreover, an embodiment of the present invention may contain a TCP/IP stack or any other suitable communication stack to allow for connection to one or more networked devices. In addition to this, a preferred embodiment of the present invention uses at least one of a plurality of database formats including SQLite, SQL and MySQL to store plate records, images and videos. A preferred embodiment of the present invention is designed to have low power consumption and small form factor to make it suitable for a variety of covert and overt LPR applications. As an example, in one embodiment the LPR apparatus is fitted in a covert pole-mounted enclosure in a surveillance application. In another embodiment a car-mounted enclosure houses the LPR apparatus for law enforcement application. In yet another embodiment the LPR apparatus is housed inside a camera enclosure. Electrical power can be supplied to the LPR processing apparatus via a battery, power adaptor or using Power-over-Ethernet (PoE). It may be noted that in the embodiment of FIG. 2 a DSP is shown as the main processor. It would be apparent to those skilled in the art that the DSP can be replaced by a general purpose processor, a RISC processor, a customized ASIC design, a VLIW processor, an FPGA or any other processing architecture.

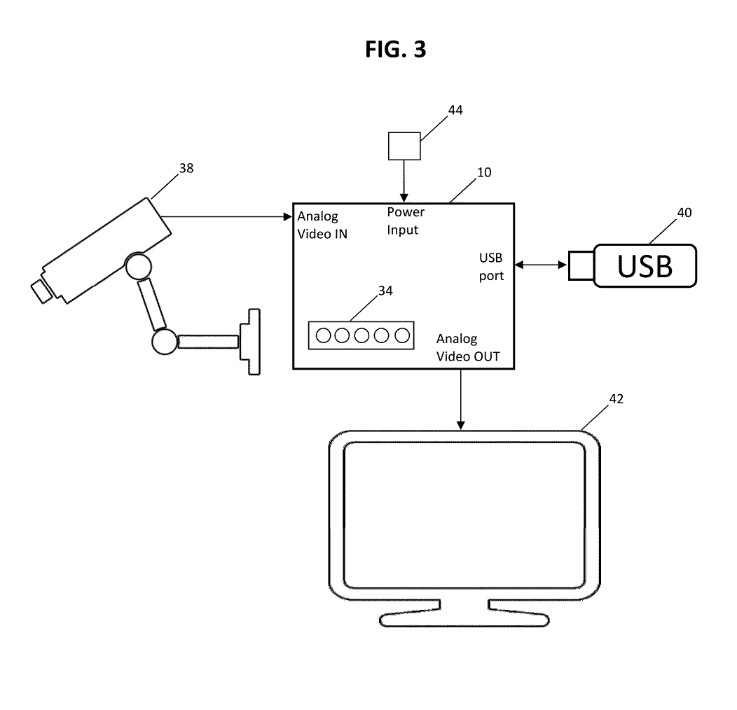

The configurable operating modes of the LPR processing apparatus 10 of the present invention allow it to be deployed in various forms, as depicted in FIGS. 3-7, 8-10, 11-13, 14-17, 18, 19-20, 21 and 22.

In FIG. 3, the processing apparatus is operating in a standalone configuration without invoking its remote web based connectivity options. The LPR processing apparatus 10 receives video signal from an analog IR camera 38 via the analog video input port, processes the video signal, captures and reads the license plates, and stores the plate records along with their images on an externally connected USB storage device 40. A user can interact with the processing apparatus 10 via the front panel button interface 34, and can view and search the LPR results on an analog monitor 42 connected via the analog video out port. The LPR results rendered on the analog monitor include IR camera video overlaid with captured plate results and hot plate captures. The LPR apparatus 10 receives power input from a power source such as a power adapter or battery 44.

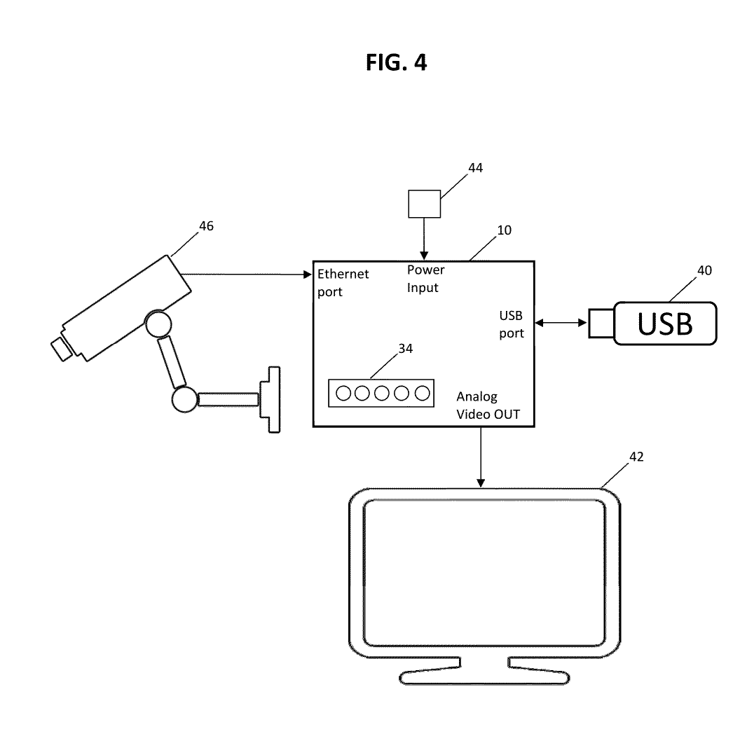

In FIG. 4, the processing apparatus is again operating in a standalone configuration without invoking its remote web based connectivity options. The LPR processing apparatus 10 receives encoded video signal from an IP camera 46 via the Ethernet port, decodes the video signal, captures and reads the license plates, and stores the plate records along with their images on an externally connected USB storage device 40. A user can interact with the processing apparatus 10 via the front panel button interface 34, and can view and search the LPR results on an analog monitor 42 connected via the analog video out port. The LPR results rendered on the analog monitor include IR camera video overlaid with captured plate results and hot plate captures. The LPR apparatus 10 receives power input from a power source such as a power adapter or battery 44.

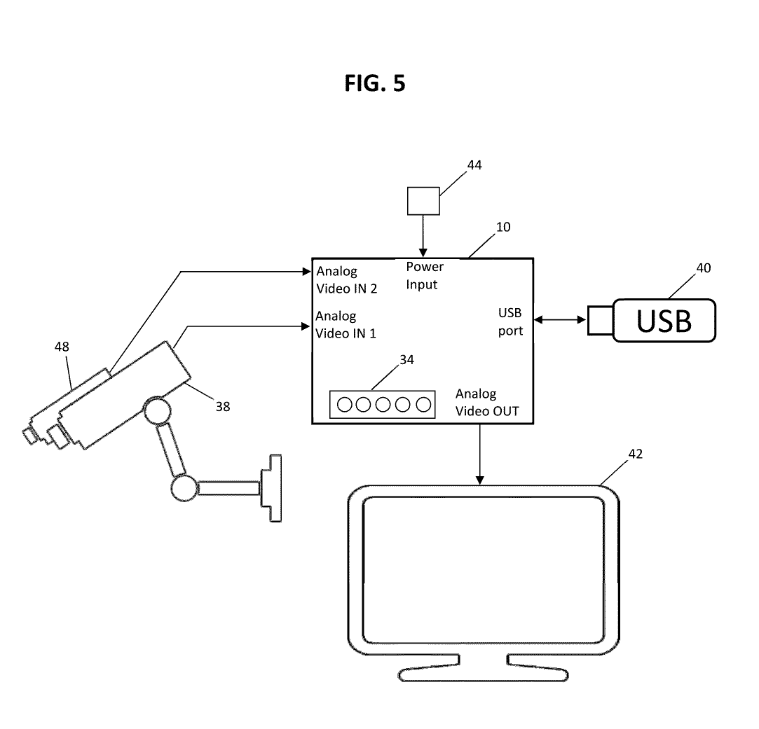

In FIG. 5, the LPR processing apparatus 10 receives two video signals from two analog cameras, simultaneously. The processing apparatus is again operating in a standalone configuration without invoking its remote web based connectivity options. IR LPR camera 38 is connected via the analog video input port 1, while color overview camera 48 is connected via the analog video input port 2. The LPR processing apparatus processes the IR LPR camera video signal, captures and reads the license plates, and stores the plate records along with their images on an externally connected USB storage device 40. Similarly, the LPR apparatus captures the corresponding color overview images of the vehicle from the color camera's signal, processes them, and stores them in the USB storage device as part of the plate records. A user can interact with the processing apparatus 10 via the front panel button interface 34, and can view and search the LPR results on an analog monitor 42 connected via the analog video out port. The LPR results rendered on the analog monitor include IR camera video overlaid with captured plate results, color overview images of vehicles and hot plate captures. The LPR apparatus 10 receives power input from a power source such as a power adapter or battery 44.

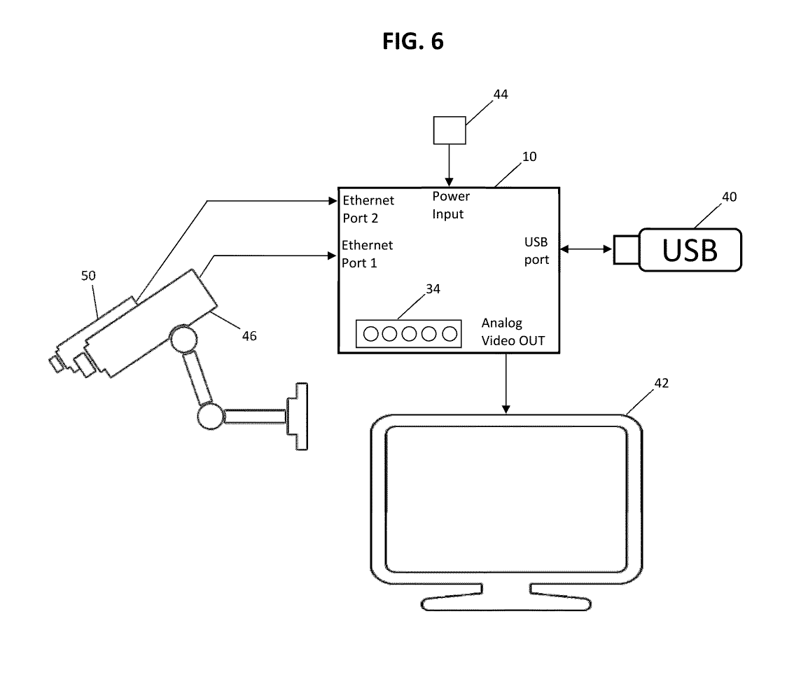

In FIG. 6, the LPR processing apparatus 10 receives two video signals from two IP cameras, simultaneously. The processing apparatus is again operating in a standalone configuration without invoking its remote web based connectivity options. IR LPR IP camera 46 is connected via the Ethernet port 1, while color overview IP camera 50 is connected via the Ethernet port 2. The LPR processing apparatus decodes the IR LPR camera video signal, captures and reads the license plates, and stores the plate records along with their images on an externally connected USB storage device 40. Similarly, the LPR apparatus captures the corresponding color overview images of the vehicle in encoded form from the color camera's signal and stores them in the USB storage device. A user can interact with the processing apparatus 10 via the front panel button interface 34, and can view and search the LPR results on an analog monitor 42 connected via the analog video out port. The LPR results rendered on the analog monitor include IR camera video overlaid with captured plate results, color overview images of vehicles and hot plate captures. The LPR apparatus 10 receives power input from a power source such as a power adapter or battery 44.

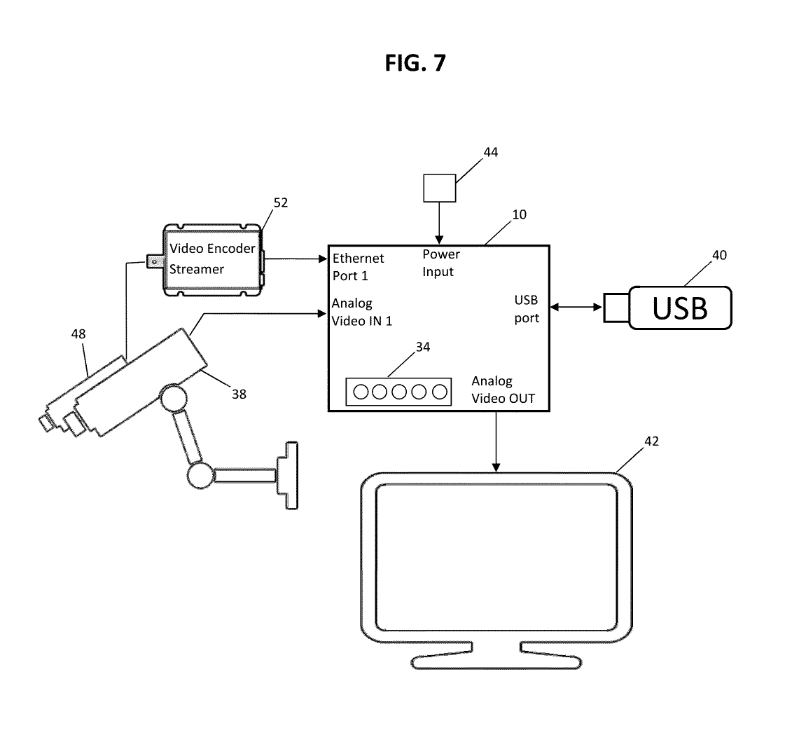

The LPR system in FIG. 7 is functioning in a similar fashion to that in FIG. 5. The difference being that the analog color overview camera 48 is connected to the LPR processing apparatus 10 through a video encoder/streamer device 52 via the Ethernet port 1. In this way the computationally demanding video encoding task of the color video signal is offloaded to the external encoder, thereby conserving the processing resources of the LPR apparatus. As in FIG. 5, the IR LPR camera 38 is connected to the LPR apparatus via the analog video input port 1. The LPR processing apparatus processes the IR LPR camera video signal, captures and reads the license plates, and stores the plate records along with their images on an externally connected USB storage device 40. Similarly, the LPR apparatus captures the corresponding color overview images of the vehicle from the color camera's signal in encoded form and stores them in the USB storage device. A user can interact with the processing apparatus 10 via the front panel button interface 34, and can view and search the LPR results on an analog monitor 42 connected via the analog video out port. The LPR results rendered on the analog monitor include IR camera video overlaid with captured plate results, color overview images of vehicles and hot plate captures. The LPR apparatus 10 receives power input from a power source such as a power adapter or battery 44.

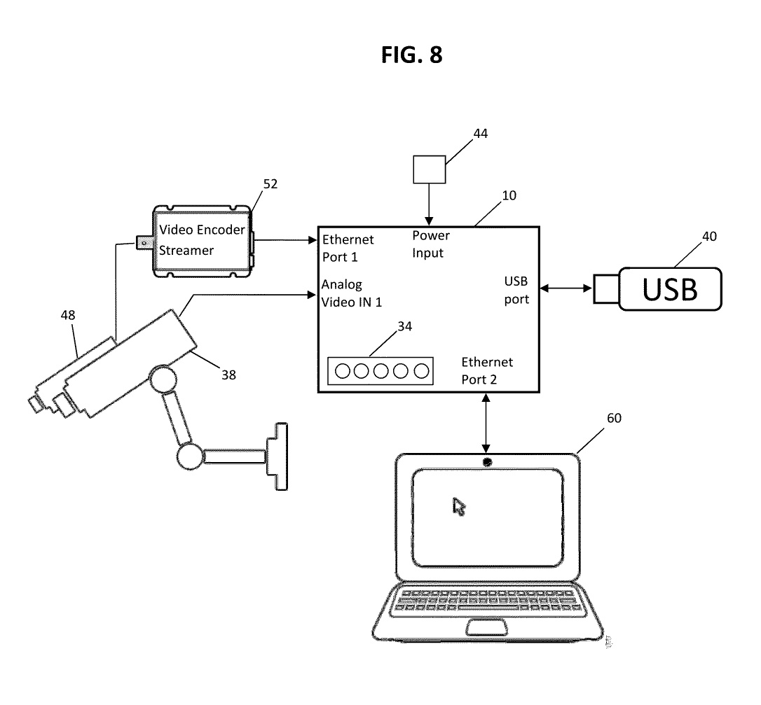

The LPR system in FIG. 8 is functioning in a similar way to that in FIG. 7. However, in FIG. 8 a personal computer (PC) 60 replaces the analog video monitor 42 of FIG. 7. The PC can be a laptop computer, a desktop computer, or any other smart device like a tablet computer or a smart phone. The computer 60 is directly connected to the LPR apparatus 10 using an Ethernet cable without any intermediate external device like a switch or router. One embodiment of the LPR apparatus 10 contains means to automatically establish wired network connection with a PC that is directly connected to its Ethernet port, without the need to manually configure the network parameters of the LPR apparatus 10 or those of the PC 60. This connection can either be established automatically or on receiving a user command via the front panel interface 34. This connection mode is especially useful if the LPR processing apparatus is to be connected to a PC without the aid of an analog video monitor. This connection mode is designed to enable accessing the LPR apparatus from a PC even when an LPR session is in progress, without disturbing the session. This mode is therefore ideal for quick system setup and/or instantaneous system monitoring via a laptop or PC. Once connected, a PC user can interact with the LPR apparatus 10 via a standard Web browser interface without having to install any special software. Using the Web browser interface the user can monitor LPR operation, conduct database searches, change system settings, manage hot license plate lists and alarms, set operating modes, manage the database, upgrade firmware and perform other control functions. The rest of the functionality of FIG. 8 is similar to that described in relation to FIG. 7.

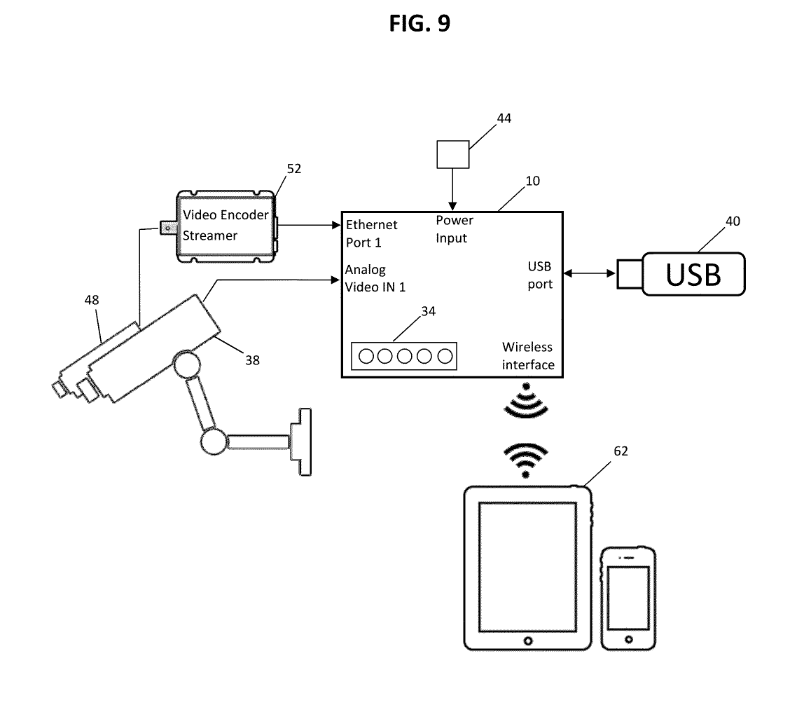

The LPR system in FIG. 9 is functioning in a similar way to that in FIG. 7. However, the embodiment of the LPR apparatus 10 in FIG. 9 is wirelessly connected to a wireless enabled device 62. The wireless enabled device can be a laptop computer, a desktop computer, or any other smart device like a tablet computer or a smart phone. One embodiment of the LPR apparatus 10 contains means to establish wireless network connection with devices supporting wireless connectivity through its wireless interface. This connection can be established automatically or on receiving a user command via the front panel interface 34. This connection mode is especially useful if the LPR processing apparatus is to be connected to a smart device without the aid of an analog video monitor, and without using an intermediate wireless access point. This connection mode is designed to enable accessing the LPR apparatus from a smart device even when an LPR session is in progress, without disturbing the session. This mode is therefore ideal for quick system setup and/or instantaneous system monitoring via a smart device. Once connected, a user can interact with the LPR apparatus 10 via a standard Web browser interface without having to install any special software. Using the Web browser interface the user can monitor LPR operation, conduct database searches, change system settings, manage hot license plate lists and alarms, set operating modes, manage the database, upgrade firmware and perform other control functions. The rest of the functionality of FIG. 9 is similar to that described in relation to FIG. 7.

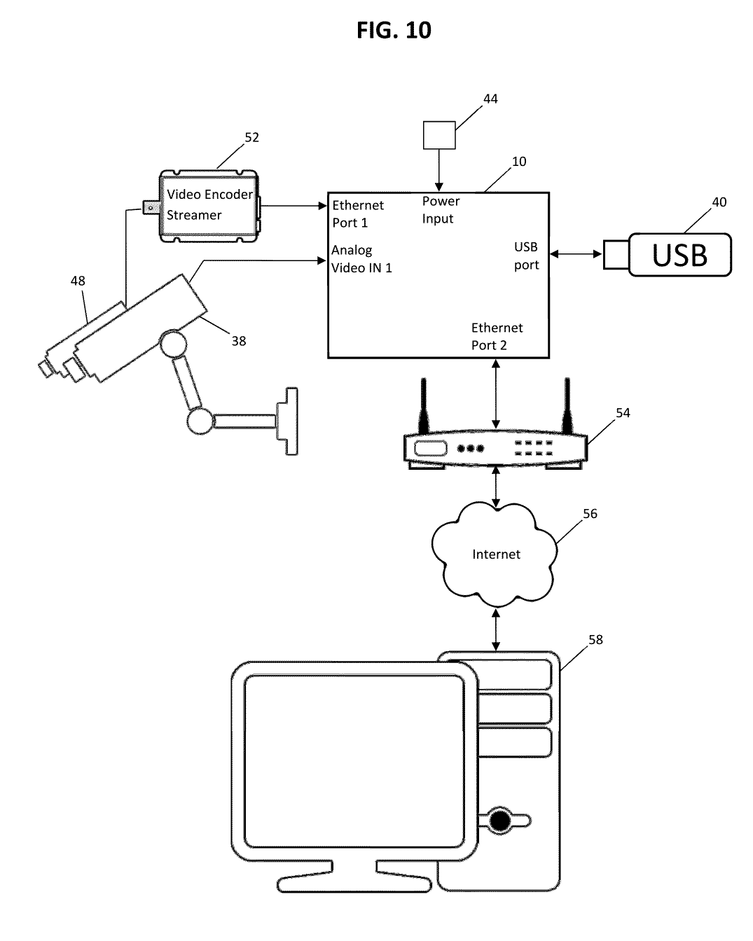

The LPR system in FIG. 10 is functioning in a similar way to that in FIG. 7. However, the embodiment of the LPR apparatus 10 in FIG. 10 is remotely connected to a computer 58 over the Internet 56 for remote monitoring and control. The computer can be a laptop computer, a desktop computer, or any other smart device like a tablet computer or a smart phone. The computer 58 is connected to the LPR apparatus 10 through Ethernet interface via an intermediate router/modem 54. The router 54 can be a DSL, a 3G/4G cellular modem, or any other communication device. This connection mode is designed to enable accessing the LPR apparatus 10 remotely from a computer 58 even when the two are placed in different geographical locations. The computer user can connect to the LPR apparatus via its Web address. Once connected, a computer user can interact with the LPR apparatus 10 via a standard Web browser interface without having to install any special software. Using the Web browser interface the user can monitor LPR operation, conduct database searches, change system settings, manage hot license plate lists and alarms, set operating modes, manage the database, upgrade firmware and perform other control functions. The rest of the functionality of FIG. 10 is similar to that described in relation to FIG. 7.

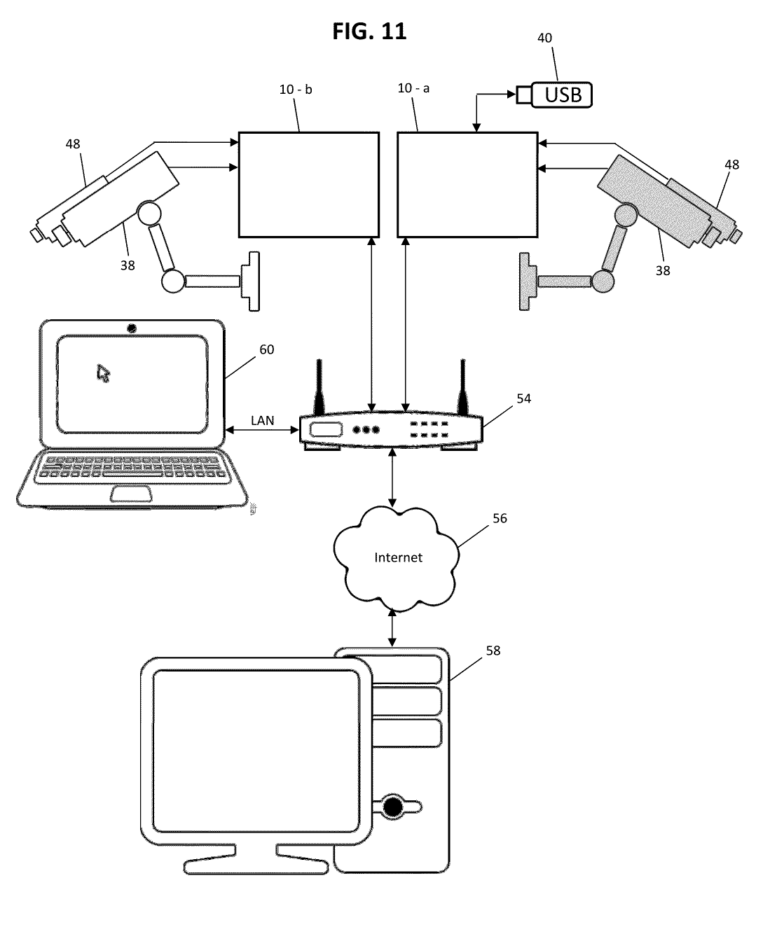

FIG. 11 is a simplified depiction of a multiple-camera LPR system utilizing a plurality of LPR processing apparatuses and corresponding LPR camera pairs. FIG. 11 shows two pairs of LPR cameras connected to two LPR processing apparatuses 10-a and 10-b, respectively. LPR processing apparatus 10-a is configured to perform LPR operation as well as act as a storage server, while LPR processing apparatus 10-b is configured to perform LPR operation without local storage. A USB storage device 40 is connected to the LPR processing apparatus 10-a to store plate records generated by the LPR processing apparatus 10-a as well as plate records coming from the LPR processing apparatus 10-b. LPR processing apparatus 10-b transmits its captured plate records to LPR processing apparatus 10-a for storage. The two LPR apparatuses of FIG. 11 are connected together via local area network (LAN) established by a router 54. Any number of LPR systems can be connected in this manner and the captured plate records, images and videos of all the systems can be stored on one storage device. A user can connect with the multiple-camera LPR system using a PC 60 over LAN, or through a remote computer 58 over Internet. To access the plate records of the entire multiple-camera LPR system the user needs only to connect to the LPR apparatus 10-a that hosts the USB storage device 40. One embodiment of the LPR processing apparatus of the present invention supports a Web browser based graphical user interface that supports multiple LPR cameras. Through this interface the user can monitor and control the entire multiple camera system by simply connecting to the LPR apparatus that is configured to act as the central storage server.

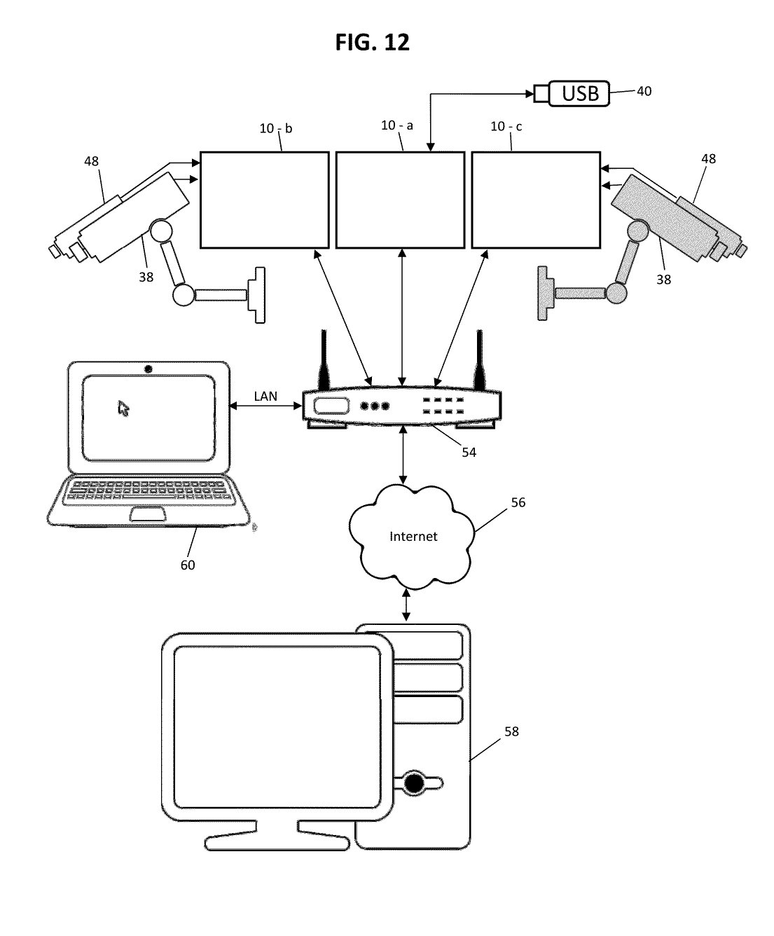

FIG. 12 is another simplified depiction of a multiple-camera LPR system utilizing a plurality of LPR processing apparatuses and corresponding LPR camera pairs. FIG. 12 shows two pairs of LPR cameras connected to two LPR processing apparatuses 10-b and 10-c, respectively. LPR processing apparatuses 10-b and 10-c are configured to perform LPR operation without local storage. A third LPR processing apparatus 10-a is attached to a USB storage device 40 and is configured to perform as a central LPR storage server without LPR processing. Hence, no LPR camera is connected to the LPR processing apparatus 10-a. It may be noted that in this configuration the number of LPR processing apparatuses utilized is one more than the number of LPR cameras. Due to the availability of additional processing resources on the central storage server apparatus 10-a, extra functionality can be provided in the form of higher definition video recording and larger sized hot lists. The USB storage device 40 connected to the LPR processing apparatus 10-a is used to store plate records, images and videos coming from the LPR processing apparatuses 10-b and 10-c. The three LPR apparatuses of FIG. 12 are connected to each other via local area network (LAN) established by a router 54. Any number of LPR systems can be connected in this manner and the captured plate records, images and videos of all the systems can be stored on one storage device. A user can interface with the multiple-camera LPR system using a PC 60 over LAN, or through a remote computer 58 over Internet. To access the plate records of the entire multiple-camera LPR system the user needs only to connect to the LPR apparatus 10-a that hosts the USB storage device 40. One embodiment of the LPR processing apparatus of the present invention supports a Web browser based graphical user interface that supports multiple LPR cameras. Through this interface the user can monitor and control the entire multiple camera system by simply connecting to the LPR apparatus that is configured to act as the central storage server.

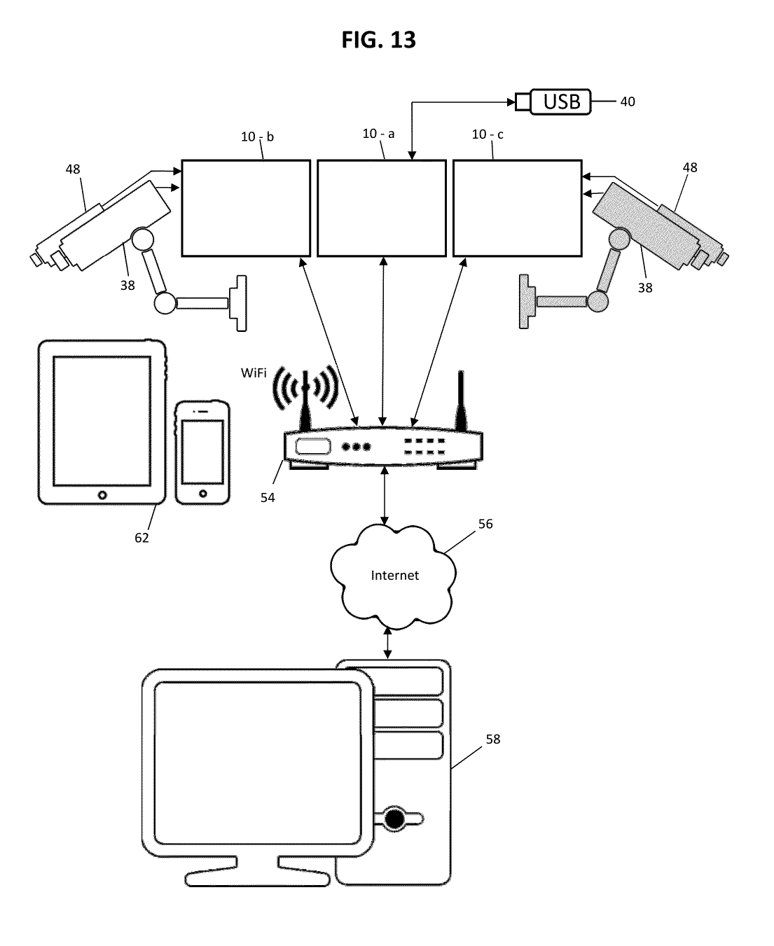

FIG. 13 is another simplified depiction of a multiple-camera LPR system that is similar to that of FIG. 12. The difference lies in the fact that a user in FIG. 13 can interface with the multiple-camera LPR system using a wireless enabled computing device 62 over a wireless network established by the router 54 acting as a wireless access point, or through a remote computer 58 over Internet. The rest of the functionality of FIG. 13 is similar to that described in relation to FIG. 12 above.

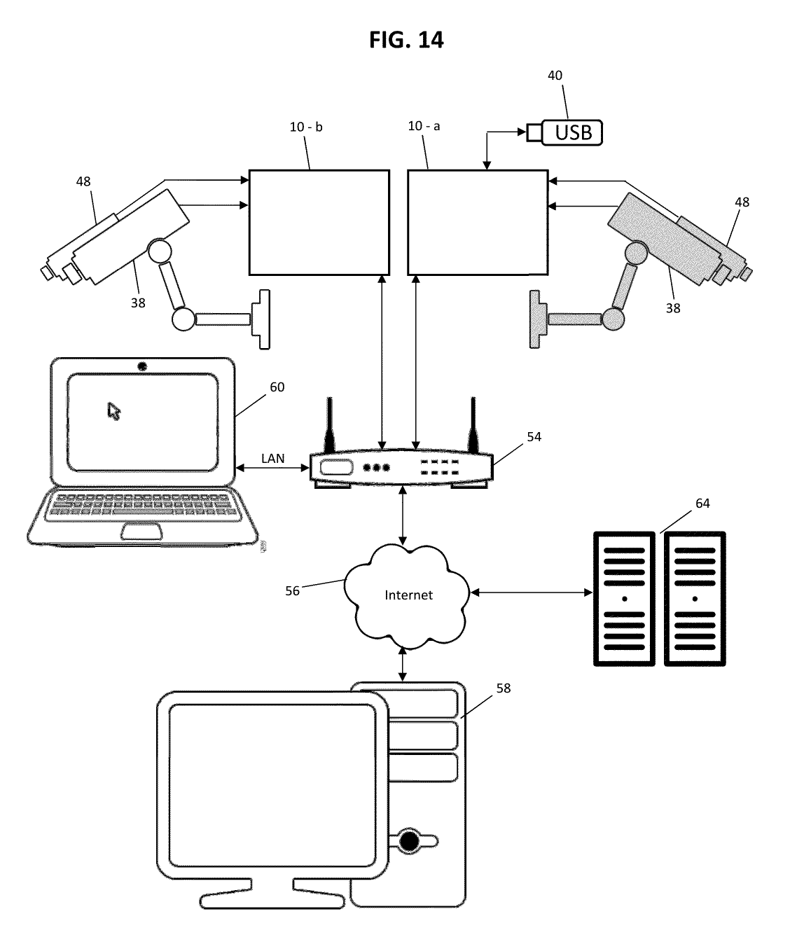

FIG. 14 is another simplified depiction of a multiple-camera LPR system that is similar to that of FIG. 11. The difference lies in the fact that the LPR processing apparatus 10-a not only stores the LPR data in the attached USB storage device 40 but also transmits it to a remote storage server 64. The storage server 64 may be placed in a different geographical location and is connected to the LPR processing apparatus 10-a through Internet. In this manner the LPR data may be exported to a remote location for long term storage and duplication. The rest of the functionality of FIG. 14 is similar to that described in relation to FIG. 11 above.

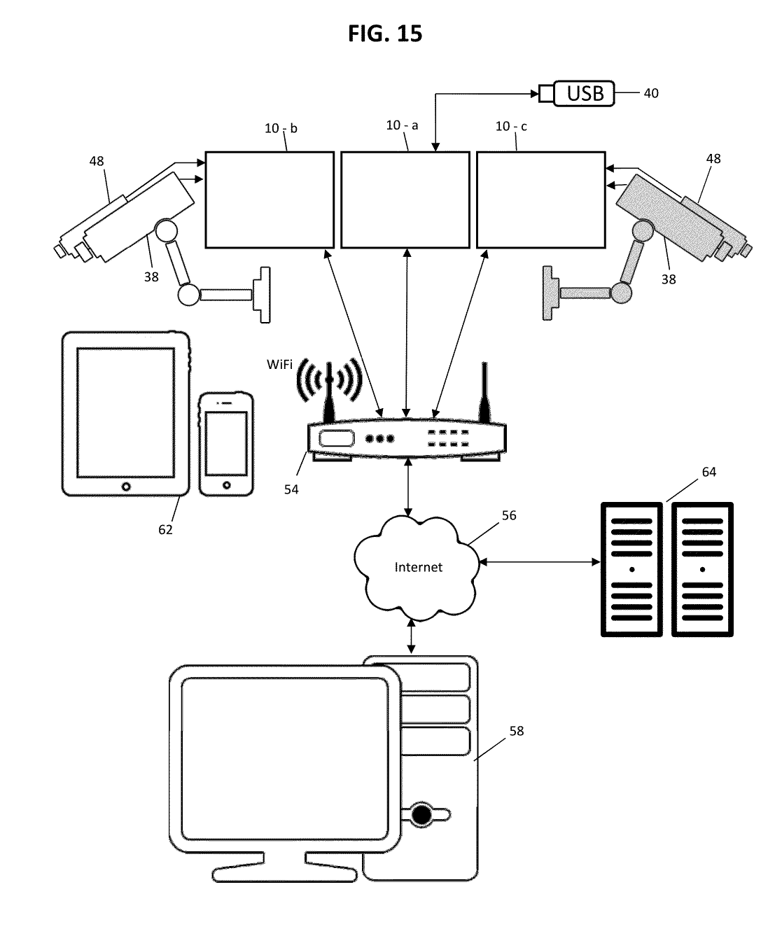

FIG. 15 is another simplified depiction of a multiple-camera LPR system that is similar to that of FIG. 13. The difference lies in the fact that the LPR processing apparatus 10-a not only stores the LPR data in the attached USB storage device 40 but also transmits it to a remote storage server 64. The storage server 64 may be placed in a different geographical location and is connected to the LPR processing apparatus 10-a through Internet. In this manner the LPR data may be exported to a remote location for long term storage and duplication. The rest of the functionality of FIG. 15 is similar to that described in relation to FIG. 13 above.

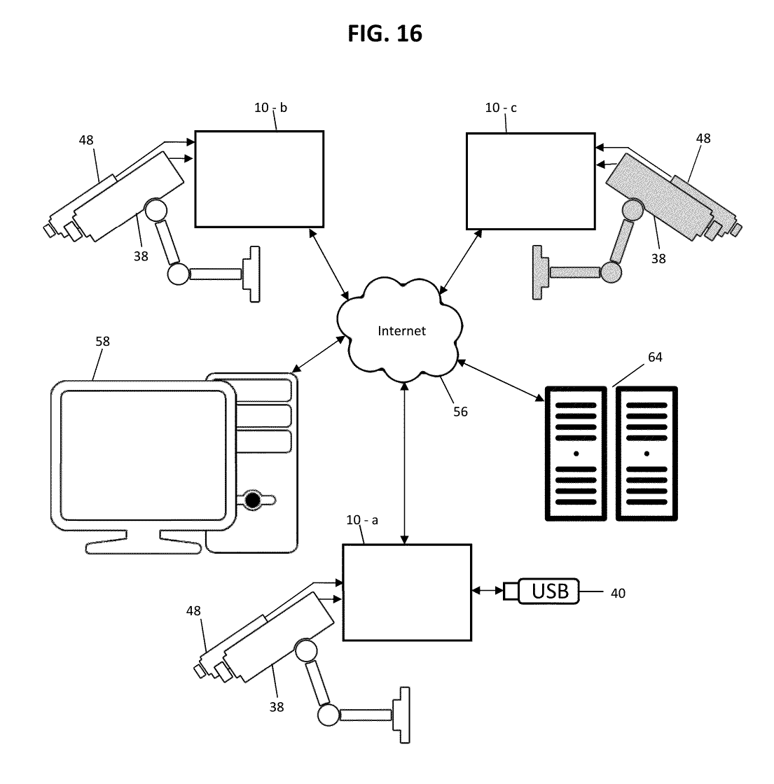

FIG. 16 is a simplified depiction of a multiple-camera LPR system where three LPR systems are placed at different geographical locations and are connected through Internet 56. LPR processing apparatuses 10-b and 10-c are configured to perform LPR operation without local storage. A third LPR processing apparatus 10-a is attached to a USB storage device 40 and is configured to perform LPR operation and also act as a central storage server. Each LPR apparatus is connected to its respective pair of analog LPR cameras. The USB storage device 40 is used by the LPR processing apparatus 10-a to store its own plate records and images as well as those coming from the LPR processing apparatuses 10-b and 10-c, respectively. A user can interface with the multiple-camera LPR system using a remote computer 58 over the Internet. To access the plate records of the entire multiple-camera LPR system the user needs only to connect to the LPR apparatus 10-a that hosts the USB storage device 40. One embodiment of the LPR processing apparatus of the present invention supports a Web browser based graphical user interface that supports multiple LPR cameras. Through this interface the user can monitor and control the entire multiple camera system by simply connecting to the LPR apparatus that is configured to act as the central storage server. The LPR processing apparatus 10-a is further configured to send its stored data to a remote storage server 64. The storage server 64 may be placed in a different geographical location and is connected to the LPR processing apparatus 10-a through Internet. In this manner the LPR data may be exported to a remote location for long term storage and duplication. It is worth pointing out that even though the depiction in FIG. 16 shows three LPR processing apparatuses, a system in this topology may in general consist of n number of LPR apparatuses where n−1 are storage less and nth is the storage server.

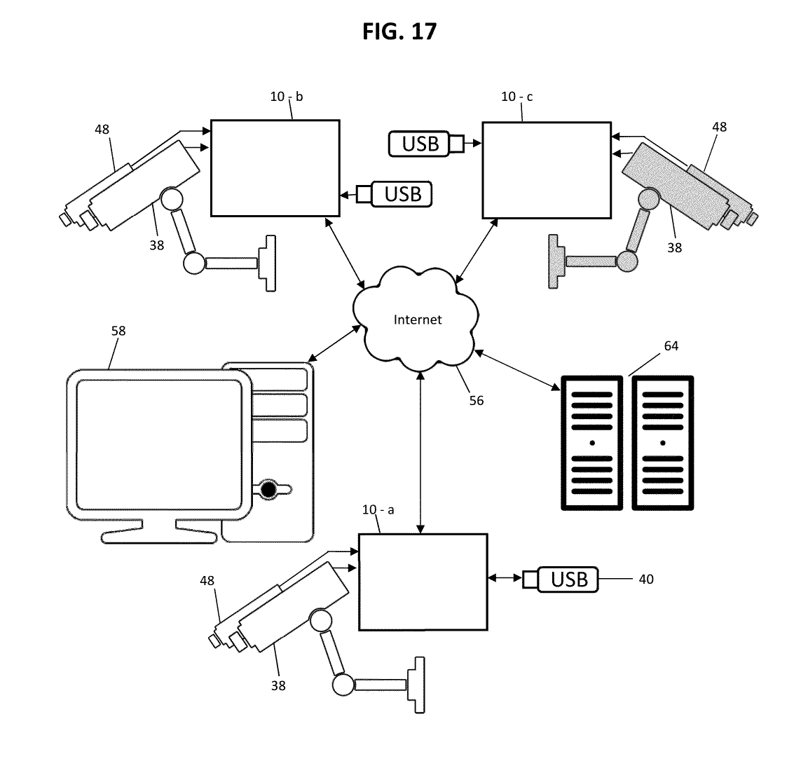

FIG. 17 is a simplified depiction of a multiple-camera LPR system similar to that of FIG. 16 where three LPR systems are placed at different geographical locations and are connected through Internet 56. The difference lies in the fact that all the three LPR processing apparatuses have their own locally connected USB storage devices. LPR processing apparatuses 10-b and 10-c are configured to perform LPR operation and send their respective plate records and images to the third LPR processing apparatus 10-a, which is configured to perform LPR operation and also act as a central storage server for the plate records and images. The three LPR processing apparatuses 10-a, 10-b and 10-c are further configured to store their captured videos in their locally connected USB storage devices. This configuration is particularly useful as it avoids transmitting the huge amount of video data over the Internet. Instead, the video data is stored in a locally connected USB storage device in a decentralized fashion. A user can interface with the multiple-camera LPR system using a remote computer 58 over the Internet. To access the plate records, images and videos of the entire multiple-camera LPR system the user needs only to connect to the LPR apparatus 10-a that hosts the USB storage device 40. If the user requests a video file that resides within the local storage of the LPR apparatus 10-a it is transferred to the user for viewing. On the other hand, if the user requests a video file that resides within the local storage of the LPR apparatuses 10-b or 10-c, the LPR apparatus 10-a redirects the user's request for video to the respective LPR apparatus. The desired video file is then transferred by the LPR apparatus 10-a or 10-b for the user to view. One embodiment of the LPR processing apparatus of the present invention supports a Web browser based graphical user interface that supports multiple LPR cameras. Through this interface the user can monitor and control the entire multiple camera system by simply connecting to the LPR apparatus that is configured to act as the central storage server. The LPR processing apparatus 10-a is further configured to send its stored data to a remote storage server 64. The storage server 64 may be placed in a different geographical location and is connected to the LPR processing apparatus 10-a through Internet. In this manner the LPR data may be exported to a remote location for long term storage and duplication. It is worth pointing out that even though the depiction in FIG. 17 shows three LPR processing apparatuses, a system in this topology may in general comprise n number of LPR apparatuses that store video data locally in n storage devices in a decentralized fashion, and the nth LPR apparatus stores plate records of the entire system.

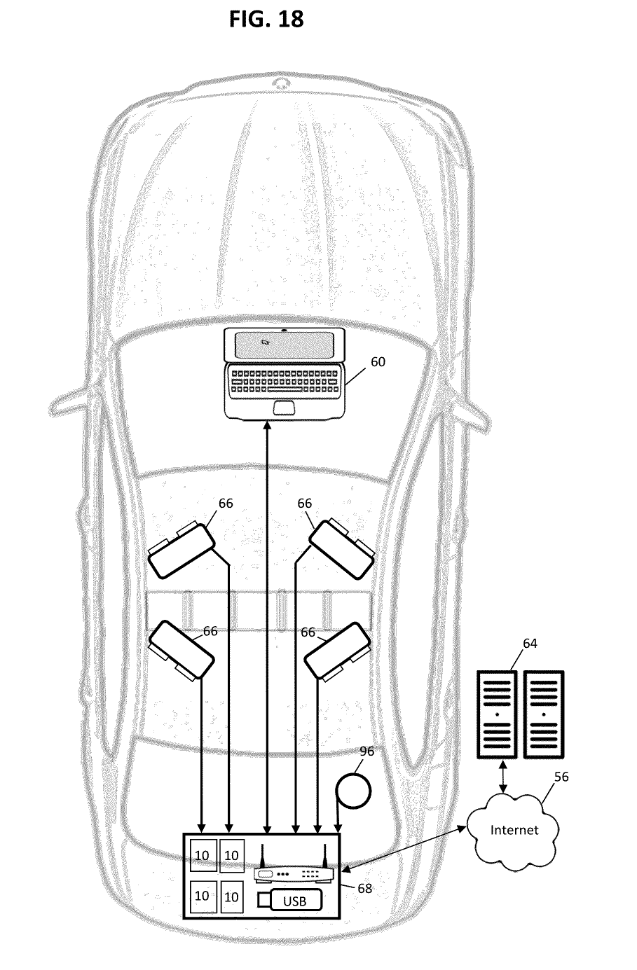

FIG. 18 depicts one embodiment of a simplified car-mounted mobile LPR system based upon the LPR processing apparatus of the present invention. It may be noted here that embodiments of car-mounted mobile LPR systems based upon the present invention having one, two, three, four or more LPR processing apparatuses and cameras can be visualized. The LPR system depicted in FIG. 18 comprises four LPR processing apparatuses, USB storage device and network router housed in an enclosure 68, which is placed in the boot compartment of the car. The LPR processing apparatuses are configured to operate in car-mounted mobile LPR mode. Similar to the multiple-camera LPR configuration of FIG. 11, the LPR processing apparatuses are connected to four composite LPR cameras 66, where each composite camera consists of an IR LPR camera and a color overview camera. One of the four LPR apparatuses has an attached USB storage device and is configured to perform LPR operation and act as a storage server, while the rest are configured to perform LPR operation only, and send their plate records to the storage server LPR unit. A GPS device 96 is attached to the storage server LPR unit to tag captured plates according to the capture locations. It is worth pointing out that in certain embodiments the GPS device may be embedded within the network router. Certain embodiments of the LPR system may also employ the GPS location information to automatically adapt the OCR parameters for different states and regions. The user interacts with the LPR system through a laptop PC 60 mounted on the car's dashboard via a Web browser interface. The PC is attached to the storage server LPR unit over a wired or wireless LAN established by the network router. Each LPR processing apparatus scans a different direction through its camera for passing cars, reads the license plates, checks for any hits in the hot lists, and stores the plate records, images and videos in the USB storage device. If Internet 56 connectivity is available the system may also be connected to a remote storage server 64 for remote data access and long term data storage. It may be noted here that the laptop PC 60 can be replaced by any smart computing device that supports Ethernet or wireless interfaces such as a tablet computer or a smart phone. Different embodiments of the mobile LPR system may also contain means to share information including targeted (hot) plate data, images and videos between a central control station and on-the-field systems.

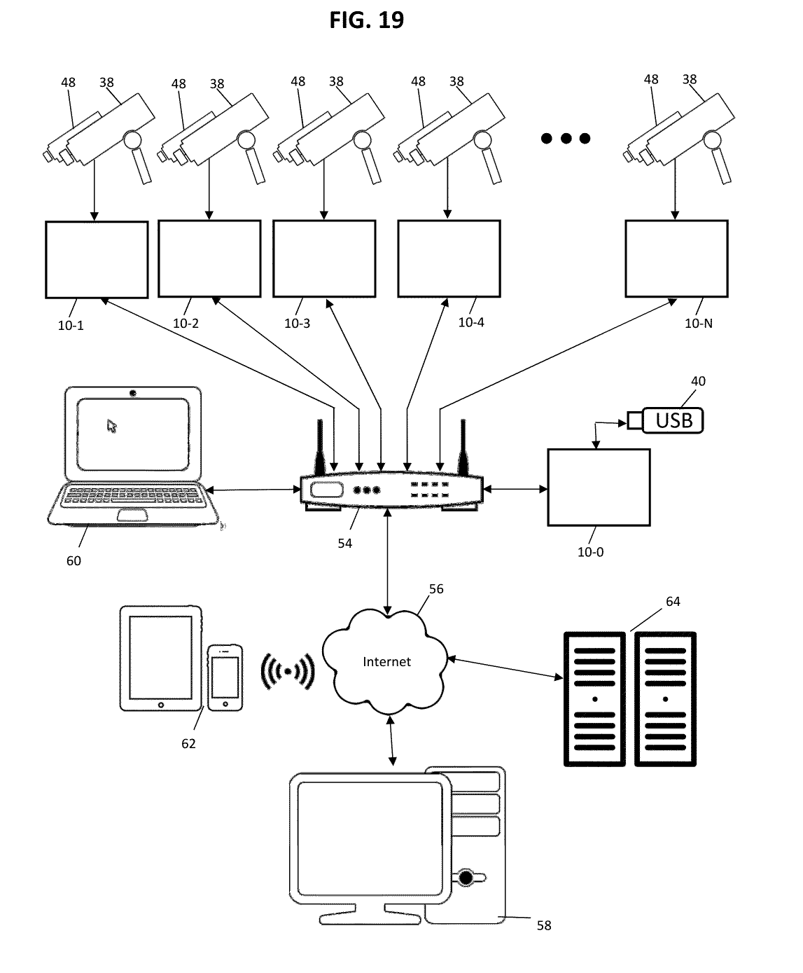

FIG. 19 is a simplified depiction of a large scale LPR system consisting of N LPR camera pairs. This is a generalization of the LPR systems depicted in FIG. 12 and FIG. 13. LPR processing apparatuses 10-1 to 10-N are configured to perform LPR operation without local storage. An additional LPR processing apparatus 10-0 is attached to a USB storage device 40 and is configured to perform as a central LPR storage server without LPR processing. Hence, no LPR camera is connected to the LPR processing apparatus 10-0. The USB storage device 40 connected to the LPR processing apparatus 10-0 is used to store plate records, images and videos coming from the LPR processing apparatuses 10-1 to 10-N. The N+1 LPR apparatuses of FIG. 19 are connected to each other via local area network (LAN) established by a router 54. A user can interface with the multiple-camera LPR system using a PC 60 over LAN, or through a remote computer 58, or a wirelessly connected computing device 62 through the Internet. To access the plate records of the entire multiple-camera LPR system the user needs only to connect to the LPR apparatus 10-0 that hosts the USB storage device 40. One embodiment of the LPR processing apparatus of the present invention supports a Web browser based graphical user interface that supports multiple LPR cameras. Through this interface the user can monitor and control the entire multiple-camera system by simply connecting to the LPR apparatus that is configured to act as the central storage server. The LPR processing apparatus 10-0 may further be configured to send its stored data to a remote storage server 64. The storage server 64 may be placed in a different geographical location and is connected to the LPR processing apparatus 10-0 through Internet 56. In this manner the LPR data may be exported to a remote location for long term storage and duplication.

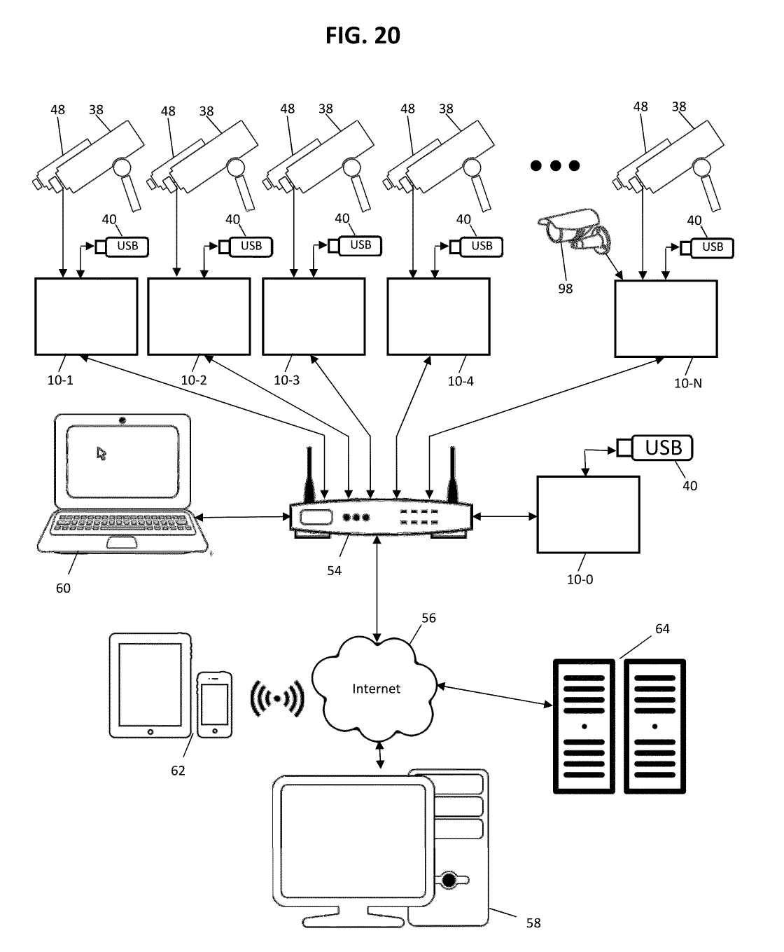

FIG. 20 is another simplified depiction of a large scale LPR system consisting of N LPR camera pairs and is similar to the system of FIG. 19. The difference lies in the fact that all LPR processing apparatuses 10-0 to 10-N have an attached USB storage device. The LPR processing apparatus 10-0 is attached to a USB storage device 40 and is configured to perform as a central LPR storage server without LPR processing. Hence, no LPR camera is connected to the LPR processing apparatus 10-0. The rest of the LPR apparatuses are configured to perform LPR operation, and to send their plate records and images to the storage server LPR processing apparatus 10-0. In one embodiment the USB storage device 40 connected to the LPR processing apparatus 10-0 is used to store plate records and images coming from the LPR processing apparatuses 10-1 to 10-N, while the USB storage devices connected to the LPR processing apparatuses (10-1 to 10-N) are used to store their respective video data. This configuration is particularly useful as it avoids transmitting the huge amount of video data over the network. Instead, the video data is stored in a locally connected USB storage device in a decentralized fashion. Another difference in the LPR system of FIG. 20 from that of FIG. 19 is that the LPR apparatus 10-N in FIG. 20 is shown attached to three video cameras including an IR camera 38, a color overview camera 48 and a surround camera 98. In one embodiment of the present invention the surround camera 98 is used to capture surroundings, in another embodiment the surround camera is used to capture in-car video footage, and in yet another embodiment the surround camera captures video footage of the driver of the car. Moreover, the surround camera may be a color camera or an IR camera. Although a single surround camera is shown in FIG. 20, it is easy to visualize an embodiment where multiple surround cameras are used. A user can interface with the multiple-camera LPR system using a PC 60 over LAN, or through a remote computer 58, or a wirelessly connected computing device 62 through the Internet. To access the plate records, images and videos of the entire multiple-camera LPR system the user needs only to connect to the LPR apparatus 10-0 that hosts the USB storage device 40. If the user requests a plate record that resides within the local storage of the LPR apparatus 10-0 it is transferred to the user for viewing. On the other hand, if the user requests a video file that resides within the local storage of the LPR apparatuses 10-1 to 10-N, the LPR apparatus 10-0 redirects the user's request for video to the respective LPR apparatus. The desired video file is then transferred by the concerned LPR apparatus for the user to view. One embodiment of the LPR processing apparatus of the present invention supports a Web browser based graphical user interface that supports multiple LPR cameras. Through this interface the user can monitor and control the entire multiple-camera system by simply connecting to the LPR apparatus 10-0 that is configured to act as the central storage server. The LPR processing apparatus 10-0 may further be configured to send its stored data to a remote storage server 64. The storage server 64 may be placed in a different geographical location and is connected to the LPR processing apparatus 10-0 through Internet 56. In this manner the LPR data may be exported to a remote location for long term storage and duplication.

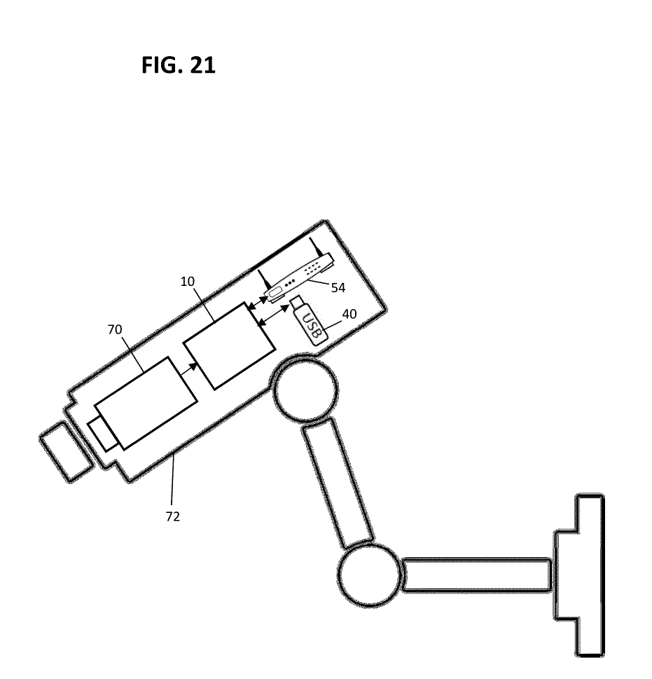

FIG. 21 is a simplified depiction of an LPR processing apparatus 10 enclosed in an LPR camera housing 72. The LPR processing apparatus receives video input signal from the camera hardware 70, performs LPR operation, and stores the results in the attached USB storage device 40. The system also includes a router/modem 54 for connecting with the outside world. In this embodiment all required LPR components depicted in FIGS. 3-10 are embedded inside a camera housing. This autonomous camera configuration with built-in LPR feature is particularly attractive for its simplicity and ease of use, and acts as an all-in-one solution.

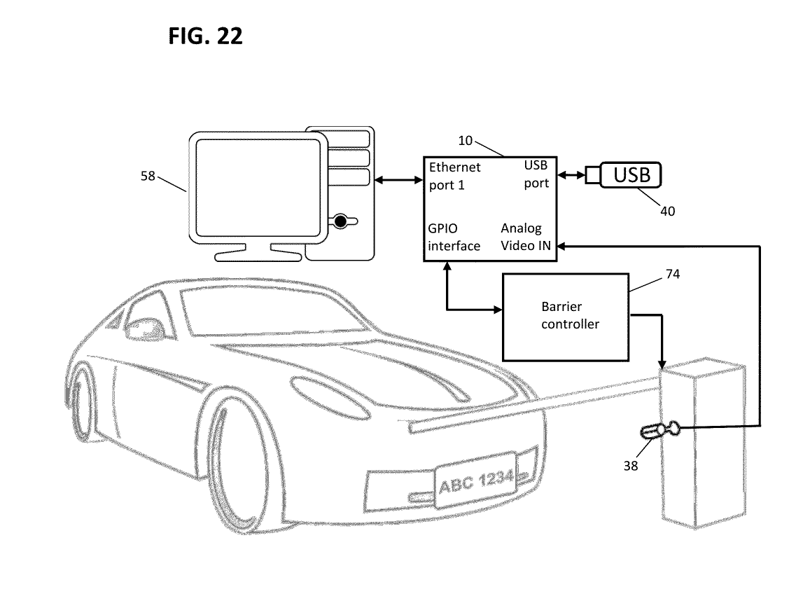

FIG. 22 depicts an embodiment of the present invention where the LPR processing apparatus is part of an automatic access control system in an LPR based entry-exit application. The embodiment of FIG. 22 demonstrates the role of the GPIO interface of the LPR processing apparatus 10 in signaling the barrier controller 74 to raise or lower the barrier. When a car arrives the LPR processing apparatus 10 captures the plate image using the camera 38, reads the plate number and passes on the results to the connected computer 58. Based upon an authorization criterion (White list/Black list) the computer directs the LPR processing apparatus to allow/disallow the car to proceed. The LPR processing apparatus generates the appropriate digital signal at its GPIO interface to cause the connected barrier controller 74 to take the appropriate action. The LPR processing apparatus also stores the plate record in the connected USB storage device 40.

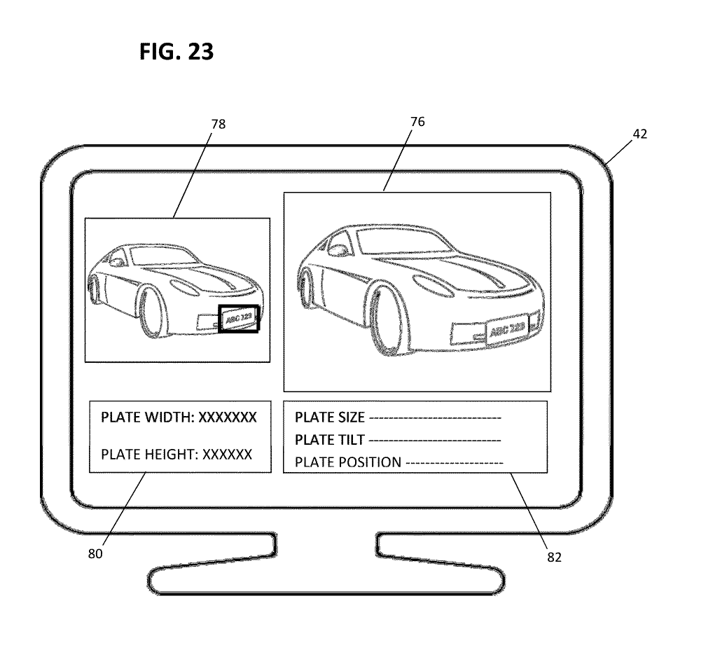

FIG. 23 depicts a GUI based camera installation mode in one embodiment of the LPR processing apparatus of FIG. 1 to facilitate LPR camera installation and positioning. When operating in this mode, one or a plurality of the user interfaces provide active graphical and textual help to assist the user in installing the LPR camera without the need of installation personnel. The camera installation mode provides video footage from the IR camera as well as the color overview camera. It displays video frames containing captured plates, and helps the user in positioning the camera correctly by providing captured plate sizes and capture positions. Furthermore, it gives warnings regarding improper camera usage including excessive tilt angles, improper capture positions and improper captured plate sizes. As shown, an analog monitor 42 displays a switchable color/IR camera live view in window 76, images of video frames with captured license plates in window 78, plate attributes including captured plate size and/or position in text window 80, and warning messages regarding improper camera usage in text window 82. Although the camera installation mode shown in FIG. 23 is shown in relation to an analog video monitor, it is also available on a network connected device through Web or wireless interfaces.

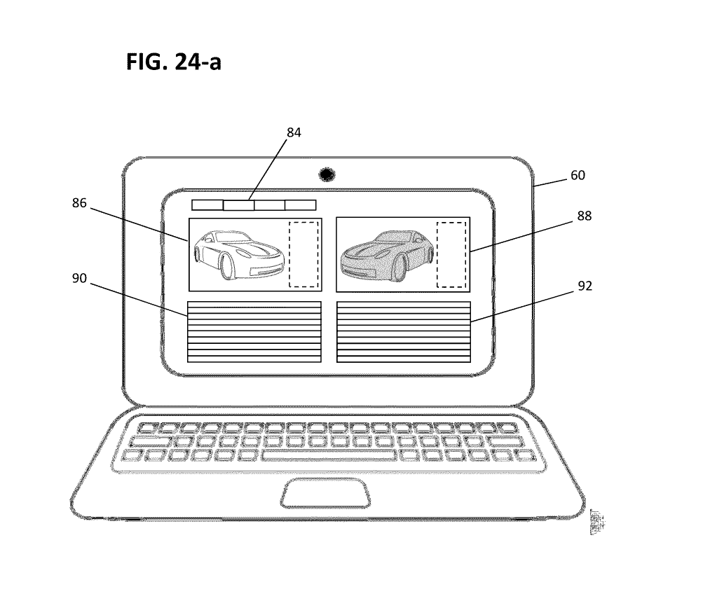

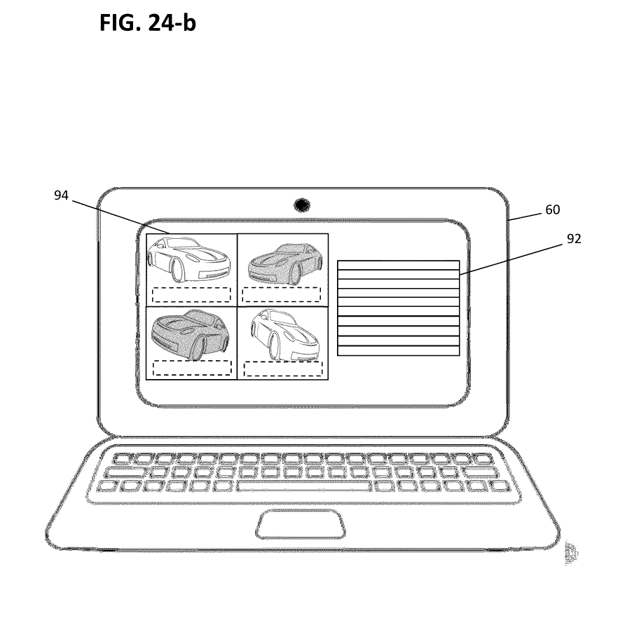

FIGS. 24a and 24b are depiction of GUI based multiple monitoring modes in one embodiment of the present invention. A user connected to the LPR system through a PC 60 can select a monitoring mode by pressing a button on the GUI. FIG. 24-a shows one monitoring mode that displays live feed of a selected LPR camera along with the most recently captured plate record in window 86, where the camera may be selected via a button interface 84. In addition to this, the most recently captured hot plate record is displayed in window 88. Furthermore, the recent history of captured plates and hot plates is displayed in lists 90 and 92, respectively. FIG. 24-b shows another monitoring mode that displays a grid-view of multiple LPR cameras and captured plates in window 94. In addition, a list 92 displays the most recently captured hot plate records. Although FIG. 24b shows the multiple monitoring modes in relation to a Laptop PC 60, they can be made available on an analog monitor or any smart device such as a tablet computer or a smart phone. Moreover, the monitoring modes can be used to monitor any number of LPR cameras, and are not limited to four cameras as shown in FIG. 24b.

An important advantage of the LPR processing apparatus of the present invention as depicted in the above paragraphs is the ease with which data can be transported from the LPR system to a central computer or facility. A user can simply detach the USB storage device from the LPR system and attach it directly to a computer for backup. Moreover, if the computer has appropriate software installed, it can analyze the LPR data in an off line fashion directly from the LPR data stored in the USB storage device and easily perform LPR data analytics such as plate recurrence analysis, connected events analysis, time lapse analysis, convoy analysis or any other. The ease of data transport is even more important in the case of video data as video takes up a lot of storage space and is difficult to transport via network. In one embodiment of the present invention, LPR records and video data captured by car-mounted LPR systems during a shift are transported to a central storage server of a law enforcement agency at the end of each shift. This is easily accomplished by detaching the USB storage devices from the car based LPR systems and attaching them to a USB hub connected to the main server and uploading the data.

Another important aspect of the LPR processing apparatus as envisaged in the present invention is that the LPR database is housed in the attached USB device and can be searched remotely via Web interface through a PC or a hand-held mobile device including a smart phone without the need to install any particular application. One or more users can connect to the LPR processing apparatus to monitor the LPR session and search its database.

Different embodiments of the present invention house the LPR processing apparatus and its accessories in self-contained portable LPR kits or drop-boxes that can be easily transported and deployed. The kits are powered up by the car battery or cigarette lighter jack and simply require connecting to the LPR camera to operate. The kits support one or a plurality of LPR cameras. In addition to these, certain embodiments of the invention use weather resilient casings for housing the LPR processing apparatus and its accessories. Certain embodiments of the present invention maintain accurate time for tagging plate records and video files by synchronizing the internal clock of the LPR apparatus with GPS time or Internet server time. Accurate time is essential for certain LPR applications such as traffic regulating and monitoring applications. Other embodiments of the present invention integrate the LPR processing apparatus with client payment systems at parking garages to automatically charge the owner of the vehicle through credit card or invoice sent in the mail.

The various illustrative logical blocks, modules, circuits, elements, and/or components described in connection with the embodiments disclosed herein may be implemented or performed with a digital signal processor (DSP), a general purpose processor, an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, micro controller, or state machine. A processor may also be implemented as a combination of computing components, e.g., a combination of a DSP and a microprocessor, a number of microprocessors, one or more microprocessors in conjunction with a DSP core, or any other such configuration. A preferred embodiment of the present invention supports a Web browser based GUI for users connected through PCs and other smart devices over a network. However, it should be readily apparent to those skilled in the art that specifically developed application software with GUI functionality can also be used to monitor and control the LPR system.

The methods or algorithms described in connection with the embodiments disclosed herein may be embodied directly in hardware, in a software module executable by a processor, or in a combination of both, in the form of control logic, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit of scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more”. All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for”.

What is claimed is:

1. A method for facilitating development of license plate recognition (LPR) applications of various kinds and forms, the method comprising:
configuring one or more configurable LPR apparatuses manually or automatically through hardware or software means to function in at least one of a plurality of operating modes, thereby acquiring the characteristics needed to set up an LPR application, where the characteristics include:
processing functionality and features needed by the LPR application,
connection types needed by the LPR application,
storage types needed by the LPR application,
user interface types needed by the LPR application, and
data interface types needed by the LPR application; and
setting up the LPR application by connecting one or a plurality of the above configured LPR apparatuses with any required additional equipment including infrared/color cameras, network routers/switches, modems, global positioning system (GPS) devices, storage devices, video encoders/decoders, display monitors and computers.

2. The method of claim 1, wherein the operating modes include one or a plurality of the following modes:
LPR processing mode with local storage of license plate data,
LPR processing mode with remote network storage of license plate data,
LPR processing mode with local and remote network storage of license plate data,
LPR processing mode for fixed camera application,
Streaming Networks LPR 0001US
LPR processing mode for mobile camera application,
LPR processing mode with overview camera video recording capability,
LPR processing mode with surround camera video recording capability,
LPR processing mode for stand-alone personal computer (PC) independent operation,
LPR processing mode for operation in conjunction with network connected PCs and other smart devices,
LPR processing mode with data-mining support to search license plate records, images and/or videos in a database,
LPR processing mode with general purpose input/output (GPIO) support,
LPR camera installation mode to help in installing infrared or color camera,
LPR processing mode with built-in network storage server capability, for storing locally generated license plate data as well as receiving and storing license plate data coming from other connected LPR apparatuses over a network, and network storage server mode without local LPR processing, for receiving and storing license plate data from other connected LPR apparatuses over a network.

3. The method of claim 1, where the LPR apparatus is comprised of a computer system with a user interface module, a mode selection and configuration module, an LPR control module, an LPR processing engine, and a data interface module.

4. The method of claim 1, wherein the LPR apparatus can be re-configured manually or automatically to modify its operating mode, attributes and interfaces according to the needs of the LPR application.

5. The method of claim 1, wherein the LPR apparatus supports multiple graphical user interfaces (GUI) tailored for analog video monitors and wired/wireless network connected devices, or wherein the LPR apparatus supports multiple control interfaces including front panel control, infra-red remote control and Web browser based control.

6. The method of claim 1, wherein the LPR apparatus can be operated through a standard web browser without the need to install any special software, or where the LPR apparatus can be operated through specifically developed application software.

7. The method of claim 1, wherein the LPR apparatus can capture and/or search from a database one or a plurality of entities including license plate records, license plate images, vehicle overview color images and video data.

8. The method of claim 1, wherein the storage device connected to the LPR apparatus houses the database, and where the storage device can be detached and reconnected to a PC or any smart device for independently searching the database.

9. The method of claim 1, wherein a network user connects to one LPR apparatus amongst a plurality of network-connected LPR apparatuses, to monitor and control a multiple-camera LPR application.

10. The method of claim 1, wherein the LPR apparatus performs one or a plurality of functionalities including capturing license plate images, reading license plates, storing license plate data, hot list management, data mining, video recording, audio recording, database management, rendering LPR results on monitors, managing the graphical user interfaces, firmware upgrading, event tagging, system settings, managing GPIO signals, handling GPS data and communicating with web browsers and external applications.

11. The method of claim 1, wherein the LPR apparatus is embedded within a camera enclosure, or where the LPR apparatus is integrated in a video management system (VMS).

12. The method of claim 1, wherein the LPR apparatus performs exact, partial, fuzzy and wild-card searches to seek out the license plate records of complete or incomplete plate reads in the stored database or hot lists.

13. The method of claim 1, wherein the LPR apparatus supports one or a plurality of hot lists and where a hot list may be a black list or a white list, or where the LPR apparatus transmits captured hot plate records as Email or SMS messages to a desired address.

14. The method of claim 1, wherein one or a plurality of data types including license plate records, license plate images, vehicle images, vehicle videos and surrounding videos are stored either in a central storage server or in edge-based decentralized storage devices, or where the data is stored both in a central storage server as well as in edge-based decentralized storage devices.

15. The method of claim 1, wherein the LPR apparatuses are used in one or more LPR applications including security and surveillance, law enforcement, parked car scanning, entry-exit systems, automatic vehicle access control, toll collection, community data logging, school bus safety, drive through customer service, monitoring financial institutions/business concerns, traveling time measurement, border security, electronic fencing, traffic monitoring and convoy analysis.

16. The method of claim 1, wherein a plurality of LPR apparatuses are connected to each other via a local area network (LAN) or via a wide area network (WAN).

17. The method of claim 1, wherein the LPR apparatus performs optical character recognition (OCR) function on the captured license plate images either in real-time or in an off-line fashion, or where the LPR apparatus carries out database searching on-the-fly while the LPR process is in progress or in an off-line fashion.

18. The method of claim 1, wherein the LPR apparatus provides multiple selectable monitoring modes including single-camera view and grid-view for one or more LPR cameras.

19. The method of claim 1, wherein a camera installation mode is available on one or a plurality of display devices including an analog video monitor, a network connected PC and a wirelessly connected smart device.

20. An LPR system comprising a global positioning system (GPS) module, wherein the LPR system utilizes GPS location information produced by the GPS module to automatically adapt the OCR parameters for reading license plates of different geographical regions.
